(19) United States
(12) Patent Application Publication
(10) Pub. No.: US 2005/0152232 A1
(43) Pub. Date: Jul. 14, 2005

(54) Copy window control for data dependent field switching in domain expansion read-out

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips electronics N.V., 5621 BA Eindhoven (NL)

(21) Appl. No.: 10/509,474

(22) PCT Filed: Mar. 14, 2003
(86) PCT No.: PCT/IB03/01065

(51) Int. Cl. G11B 11/00

(52) U.S. Cl. 369/13.02; 369/13.24

(57) ABSTRACT

The present invention relates to a method and apparatus for controlling a copy window during read-out of a domain expansion medium (10), wherein a switching time of an external magnetic field is derived from a reading pulse. A shift in the timing of said reading pulse is used for controlling the size of the copy window. Thereby, read-out errors due to changes in the size of the copy window can be prevented.

The present invention relates to a method and apparatus for controlling a copy window in a read-out operation of a domain expansion recording medium, such as a MAMMOS (Magnetic AMplifying Magneto-Optical System) disk, comprising a recording or storage layer and an expansion or read-out layer.

In magneto-optical storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of the laser. For read-out of the small crescent shaped marks recorded in this way, Magnetic Super Resolution (MSR) or Domain Expansion (DomEx) methods have been proposed. These technologies are based on recording media with several magneto-static or exchange-coupled RE-TM layers. According to MSR, a read-out layer on a magneto-optical disk is arranged to mask adjacent bits during reading, while, according to domain expansion, a domain in the center of a spot is expanded. The advantage of the domain expansion technique over MSR results in that bits with a length below the diffraction limit can be detected with a similar signal-to-noise ratio (SNR) as bits with a size comparable to the diffraction limited spot. MAMMOS is a domain expansion method based on magneto-statically coupled storage and read-out layers, wherein a magnetic field modulation is used for expansion and collapse of expanded domains in the read-out layer.

In the above mentioned domain expansion techniques, like MAMMOS, a written mark from the storage layer is copied to the read-out layer upon laser heating with the help of an external magnetic field. Due to the low coercivity of this read-out layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

The laser power used in the read-out process should be high enough to enable copying. On the other hand, a higher laser power also increases the overlap of the temperature induced coercivity profile and the stray field profile of the bit pattern. The coercivity Hc decreases and the stray field increases with increasing temperature. When this overlap becomes too large, correct read-out of a space is no longer possible due to false signals generated by neighboring marks. The difference between this maximum and the minimum laser power determines the power margin, which decreases strongly with decreasing bit length. Experiments have shown that with the current methods, bit lengths of 0.10 μm can be correctly detected, but at a power margin of virtually nothing (1 bit of a 16 bit DAC). Thus, for highest densities the power margin remains quite small so that optical power control during read-out is essential.

In conventional MAMMOS read-out, the external magnetic field is modulated with a period corresponding to the size of a channel bit. Thus, a bit decision is made for each channel bit (mark or space, i.e. up or down magnetization). However, synchronization of the external field modulation with the bit pattern on the disc is critical. For example, when the copy window indicating the spatial width of the copy operation is close to its maximum size for correct read-out, a small phase error already introduces a false peak. For this synchronization, timing fields and/or a wobble in the track can be used. In this way, quite reasonable frequency control is possible, but phase errors are very difficult to avoid. To achieve better synchronization of the external field, read-out methods have been described that allow timing information to be obtained from (user) data on the record carrier, e.g. disc, by using data dependent switching of the external field. By using this information e.g. as input for a clock generator, e.g. a phase locked loop circuit, or a timing control circuit, synchronization can be improved.

However, non-uniformities in the magnetic and/or optical properties of the record carrier (e.g. layer thickness), thermal drift of the laser diode or changes in the ambient temperature may lead to a change in the copy window size. Such a change in the copy window size will cause a shift in the timing of the MAMMOS signals (reading pulses) and thus also in the timing information used for synchronizing the external magnetic field, leading to read-out errors.

It is an object of the present invention to provide a method and apparatus for controlling a copy window, by means of which read-out errors due to changes in the copy window size can be prevented.

This object is achieved by providing a method according to the invention as claimed in claim 1 and by providing an apparatus as claimed in claim 16 for carrying out a method according to the invention.

Accordingly, changes in the copy window size can be easily determined from the corresponding timing shift of the reading pulse, while the determined shift is then used to control the copy window. Thereby, the size of the copy window can be maintained within a desired range. The changes of the copy window size are usually quite slow compared to the channel clock. Only local contamination like dust or fingerprints approaches this clock frequency, but is easily traced and corrected by monitoring the reflected radiation power of the pickup system using e.g. a forward sense diode, as in current optical phase-change recording systems. Hence, timing shifts in the reading signal due to changes in the copy window size can be easily distinguished and selected from shifts due to timing variations and can be used to control the size of the copy window.

The timing shift may be determined based on a difference between a time delay measured between the switching time and the reading pulse and a detected space run length related to the time delay. In this case, the copy window size may be reduced by a predetermined amount if the difference is smaller than zero, and the copy window size is increased by a predetermined amount if the difference is larger than zero. Preferably, the timing shift is obtained by an averaging operation to prevent an influence by short term fluctuations, e.g. jitter components.

Furthermore, the copy window size may be controlled by changing the radiation power and/or the external magnetic field, used for the read-out. Particularly, the external magnetic field may changed by changing a coil current supplied to a magnetic head. The change of the laser power may be used for a coarse control function, and the change of the external magnetic field may used for a fine control function, or vice versa.

Preferably, the predetermined amounts of the size change may be obtained from a look-up table or a functional relationship. The look-up table or the functional relationship define a relation between the copy window size and the radiation power and/or the external magnetic field. The radiation power may be controlled based on the reading velocity. In addition thereto, the look-up table defines a relation between a radius of the recording medium and the radiation power, to thereby obtain a substantially constant read-out temperature irrespective of the reading velocity. The look-up table may define an interpolation between an inner and outer radius of the recording medium.

Furthermore, a run length violation may be determined if the copy window size is larger than a first threshold value or smaller than a second threshold value. The threshold violations may be detected by calculating a running digital sum of signals from a DC free modulation code. The copy window size may be measured or corrected using pre-recorded control information of the recording medium.

Other advantageous further developments are defined in the dependent claims.

In the following, the present invention will be described on the basis of a preferred embodiment with reference to the accompanying drawings in which:

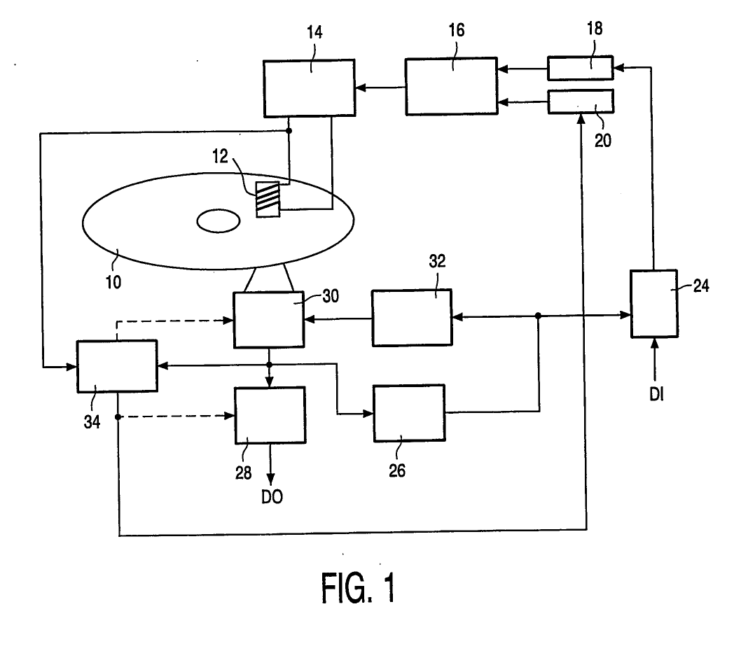

FIG. 1 shows a schematic diagram of a magneto-optical disk player, according to an embodiment of the invention;

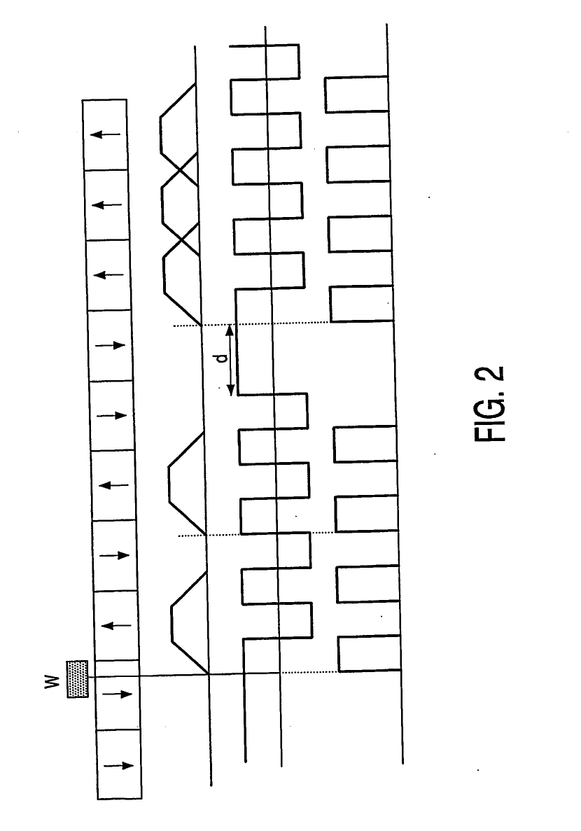

FIG. 2 shows read-out waveforms for a MAMMOS read-out operation with a fixed field period corresponding to one channel bit length and a copy window size corresponding to the half of one channel bit length; and

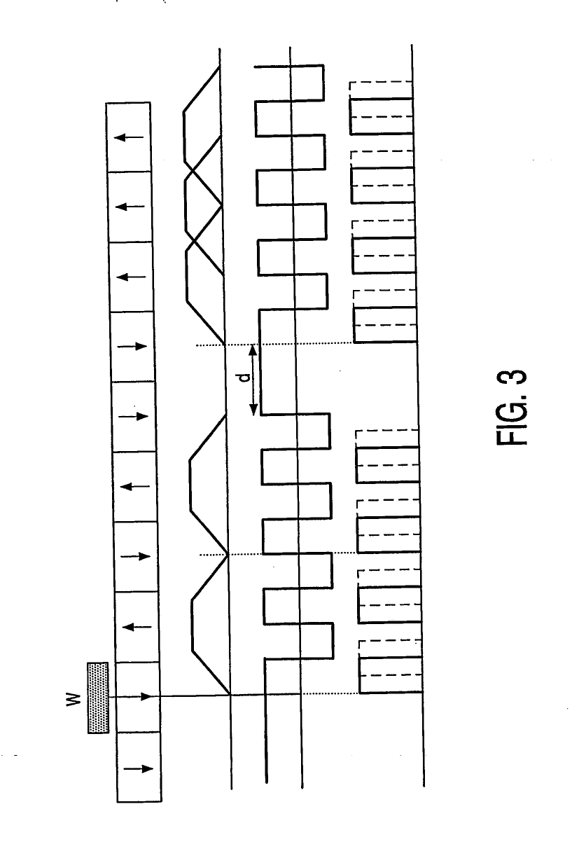

FIG. 3 shows read-out waveforms for read-out operations with an increased window size and a fixed field period corresponding to one channel bit length.

A preferred embodiment will now be described on the basis of a MAMMOS disk player as indicated in FIG. 1.

FIG. 1 schematically shows the construction of the disk player according to the preferred embodiment. The disk player comprises an optical pick-up unit 30 having a laser light radiating section for irradiation of a magneto-optical recording medium or record carrier 10, such as a magneto-optical disk, with light that has been converted, during recording, to pulses with a period synchronized with code data and a magnetic field applying section comprising a magnetic head 12 which applies a magnetic field in a controlled manner at the time of recording and playback on the magneto-optical disk 10. In the optical pick-up unit 30 a laser is connected to a laser driving circuit which receives recording and read-out pulses from a recording/read-out pulse adjusting unit 32 to thereby control the pulse amplitude and timing of the laser of the optical pick-up unit 30 during a recording and read-out operation. The recording/read-out pulse adjusting circuit 32 receives a clock signal from a clock generator 26 which may comprise a PLL (Phase Locked Loop) circuit.

It is noted that, for reasons of simplicity, the magnetic head 12 and the optical pickup unit 30 are shown on opposite sides of the disk 10 in FIG. 1. However, according to the preferred embodiment, they should be arranged on the same side of the disk 10.

The magnetic head 12 is connected to a head driver unit 14 and receives, at the time of recording, code-converted data via a phase adjusting circuit 18 from a modulator 24. The modulator 24 converts input recording data DI to a prescribed code.

At the time of playback, the head driver 14 receives a timing signal via a playback adjusting circuit 20 from a timing and control circuit 34, wherein the playback adjusting circuit 20 generates a synchronization signal for adjusting the timing and amplitude of pulses applied to the magnetic head 12. The timing and control circuit 34 derives its timing signal from the data read-out operation, as described later. Thus, a data dependent field switching can be achieved. A recording/playback switch 16 is provided for switching or selecting the respective signal to be supplied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to decode the reading signal to generate output data DO. Furthermore, the reading signal generated by the optical pick-up unit 30 is supplied to a clock generator 26 in which a clock signal obtained from embossed clock marks of the disk 10 is extracted, and which supplies the clock signal for synchronization purposes to the recording pulse adjusting circuit 32 and the modulator 24. In particular, a data channel clock may be generated in the PLL circuit of the clock generator 26. It is noted that the clock signal obtained from the clock generator 26 may as well be supplied to the playback adjusting circuit 20 to thereby provide a reference or fallback synchronization which may support the data dependent switching or synchronization controlled by the timing and control circuit 34.

In case of data recording, the laser of the optical pick-up unit 30 is modulated with a fixed frequency corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The recording data are modulated and code-converted by the modulator 24 to obtain a binary run length information corresponding to the information of the recording data.

The structure of the magneto-optical recording medium 10 may correspond to the structure described in the JP-A-2000-260079.

In the embodiment shown in FIG. 1, the timing and control circuit 34 is provided for supplying a data dependent timing signal to the playback adjusting circuit 20. As an alternative, the data dependent switching of the external magnetic field may as well be achieved by supplying the timing signal to the head driver 14, so as to adjust the timing or phase of the external magnetic field. The required timing information is obtained from the (user) data on the disc 10. To achieve this, the playback adjusting circuit 20 or the head driver 14 are adapted to control the magnetic head so as to generate an external magnetic field which is normally in the expansion direction. When a rising signal edge of a reading pulse, i.e. a MAMMOS peak, is observed by the timing and control circuit 34 at the output of the optical pickup unit 30, the timing signal is supplied to the playback adjusting circuit 20 such that the head driver 14 is controlled to reverse the magnetic field after a short time to collaps the expanded domain in the read-out layer, and shortly after that reset the magnetic field to the expansion direction. The total time between the peak detection and the field reset is set by the timing and control circuit 34 to correspond to one channel bit length on the disk 10 (times the linear disc velocity).

With the data dependent field switching method mentioned above synchronization is no longer required during read-out, as the switching time is derived directly from the data.

The derived switching times can be used to further advantage as input for the PLL circuit of the clock generator 26 to provide accurate data clock for (more) precise data recovery e.g. based on a space run length information as explained later.

FIGS. 2 an 3 show diagrams schematically indicating (from top to bottom) a storage layer with its mark and space regions (indicated by upward and downward arrows, respectively) and with a copy window size w indicating the spatial width of the copy operation, and waveforms of an overlap signal, the alternating external magnetic field and the MAMMOS read-out signal. The overlap signal indicates a time-dependent value of the overlap between the coercivity profile and the stray field, which leads to a MAMMOS signal or peak when an external magnetic field is applied. In particular, a MAMMOS peak will be generated during the time period of the positive external magnetic field. Due to the fact that the overlap signal may extend until a neighbouring (previous or next) positive period of the external magnetic field, additional peaks can be generated in the MAMMOS signal.

In FIG. 2, a storage layer with a data pattern comprising two -I2 space run lengths (each corresponding to a continuous space region of two channel bit lengths, i.e. two downward arrows, “−” indicates a space) and one 13 mark run length (corresponding to a continuous mark region of three channel bit lengths, i.e. three upward arrows) is shown. For a copy window size w larger than zero, e.g. equal to half the channel bit length b (as shown in FIG. 2), each mark run length will give at least one more MAMMOS peak than its length divided by the channel bit length which corresponds to one section in the schematically drawn storage layer. Thus, an I1 mark run length (one channel bit length) will give two MAMMOS peaks instead of one, an I2 mark run length (length 2b) will give three MAMMOS peaks instead of two, etc. However, it is clear that a space run length equal to one channel bit length has no delay, so that it can't be detected.

The space run lengths can be derived from the time or delay d that the magnetic field stays in the expansion direction (positive values) before the next MAMMOS peak appears. This time delay d is indicated in FIGS. 2 and 3. When a rising signal edge of the magnetic field is observed by the timing and control circuit 34 based e.g. on the output signal of the head driver 14, a timer circuit or timer function provided in the timing and control circuit 34 is started, which counts the time until a rising signal edge of the next MAMMOS peak is detected at the output of the optical pickup circuit 30. In particular, the delay d determined at the timing and control circuit 34 is a smooth function of the space run length. The determined delay d can be supplied from the timing and control circuit 34 to the decoder 28, such that a correct or precise decoding function for the space run lengths can be achieved. Hence, space run lengths in this scheme can be derived from the time (or: delay) that the magnetic field is in the expansion direction before the next MAMMOS peak appears. Due to the fact that this delay time has no fixed period, time shifts smaller than the channel bit length can be determined and used for controlling the copy window size, as follows.

In the diagrams of FIG. 3, the copy window size has increased, e.g. due to at least one of the reasons initially indicated. By comparing FIG. 2 and FIG. 3, it becomes clear that a change in the size of the copy window w causes a shift in the timing of the signals equal to Δτ=Δw/2, wherein Δw indicates the change in the copy window size and Δτ indicates the timing shift corrected for the disc velocity v. The timing shift is indicated by the dotted MAMMOS peaks which correspond to the situation in FIG. 2, i.e. to the smaller window size. As long as the copy window size lies within a predetermined allowed range, no read-out errors will occur. Then, the timing shift Δτ is equal to the difference between the measured delay d obtained from the timing and control circuit 34 and the detected space run length which is an integer multiple of the space increment, i.e. channel bit length, and the timing shift Δτ is smaller than one space increment.

If Δτ<0, which means that the timing is shift to the left in FIG. 3, i.e. the MAMMOS peaks appear earlier, the copy window size w should be reduced by a predetermined small increment, and if Δτ>0, which means that the timing is shift to the right in FIG. 3, i.e. the MAMMOS peaks appear later, the copy window size w should be increased by a predetermined small increment. In practice, an average value of the Δτ can be used for correcting or controlling the copy window size w, to thereby eliminate unwanted timing effects, such as jitter components.

The control of the copy window size w can be performed by having the timing and control circuit 34 control the pickup unit 30 so as to increase the laser power of the pickup unit 30 by a predetermined amount if Δτ>0, to thereby increase the copy window size w, and so as to decrease the laser power of the pickup unit 30 by a predetermined amount if Δτ<0, to thereby decrease the copy window size w. Alternatively, the timing circuit could be arranged to control the head driver 14 so as to increase the coil current (i.e. the external magnetic field) of the magnetic head 12 by a predetermined amount if Δτ>0, to thereby increase the copy window size w, and so as to decrease the coil current by a predetermined amount if Δτ<0, to thereby decrease the copy window size w. Furthermore, the timing circuit may be arranged to perform a combined control of laser power and coil current to improve the efficiency and/or resolution of the copy window control. In particular, a coarse control may be implemented using the laser power, while an additional fine control using the coil control may be added, and vice versa.

The amplitude or amount of the increase or decrease of the copy window size can be obtained e.g. from a look-up table or function provided at the timing and control circuit 34, by which a relation between copy window size w versus laser power and/or external field is stored or defined, respectively. For higher linear velocities of the disc 10, e.g. CAV (Constant angular velocity) operation or different read-out speeds, the laser power should be increased to reach or obtain the same temperature and thus the same copy window size w. Thus, the look-up table could also include the recording radius of the disc 10 as an additional control parameter, or an interpolation scheme between inner and outer radius.

An accidental failure of the above copy window control scheme according to the preferred embodiment, i.e. if the copy window control leads to a resulting size w>wₘₐₓ or w<wₘᵢₙ, can be used as an indication for a violation of run length constraints. This situation can be detected e.g. by calculating a running digital sum of signals from a DC free modulation code. If violations are present, then the coded output signal obtained from the pickup unit 30 is not free of DC components. Thus, the running digital sum will deviate from the correct zero value.

If w>wₘₐₓ, smallest mark or space run lengths are not present, the largest detected mark run length is larger than the maximum allowable run length, and/or the largest space run length is not present.

On the other hand, if w<wₘᵢₙ, not enough or no MAMMOS peaks are obtained from mark run lengths, too many small spaces are present, and/or the maximum space is too long.

If such a failure has been detected, dedicated run-in fields provided on the disc 10 could be used for measuring and correcting the copy window.

It is noted that the present invention can be applied to any reading system for domain expansion magneto-optical disk storage systems with data dependent field switching. The function of the timing and control circuit 34 may be provided by a discrete hardware unit or by a corresponding control program controlling a more general processing unit. The preferred embodiments may thus vary within the scope of the attached claims.

1. A method of controlling a copy window during read-out of a magneto-optical recording medium (10) comprising a storage layer and a read-out layer, wherein an expanded domain leading to a reading pulse is generated in said read-out layer by copying a mark region from said storage layer to said read-out layer upon heating by a radiation power and with the help of an external magnetic field, said method comprising the steps of:
deriving a switching time of said external magnetic field from said reading pulse;
determining a shift in the timing of said reading pulse; and
controlling the size of said copy window based on said determined timing shift.

2. A method according to claim 1, wherein said timing shift is determined based on a difference between a time delay (d) measured between said switching time and said reading pulse and a detected space run length related to said time delay.

3. A method according to claim 2, wherein said copy window size is reduced by a predetermined amount if said difference is smaller than zero, and said copy window size is increased by a predetermined amount if said difference is larger than zero.

4. A method according to claim, wherein said timing shift is obtained by an averaging operation.

5. A method according to claim wherein said copy window size is controlled by changing the radiation power and/or said external magnetic field, used for said read-out.

6. A method according to claim 5, wherein said external magnetic field is changed by changing a coil current supplied to a magnetic head (12).

7. A method according to claim 5, wherein said change of said laser power is used for a coarse control function, and said change of said external magnetic field is used for a fine control function, or vice versa.

8. A method according to claim 3, wherein said predetermined amounts are obtained from a look-up table or a functional relationship.

9. A method according to claim 8, wherein said look-up table or said functional relationship define a relation between said copy window size and said radiation power and/or said external magnetic field.

10. A method according to claim 9, wherein said radiation power is controlled based on the reading velocity.

11. A method according to claim 10, wherein said look-up table defines a relation between a radius of said recording medium (10) and said radiation power.

12. A method according to claim 10, wherein said look-up table defines an interpolation between an inner and outer radius of said recording medium.

13. A method according to claim, wherein a run length violation is determined when said copy window size is larger than a first threshold value or smaller than a second threshold value.

14. A method according to claim 13, wherein said threshold violations are detected by calculating a running digital sum of signals from a DC free modulation code.

15. A method according to claim 13, wherein said copy window size is measured or corrected using pre-recorded control information of said recording medium (10).

16. An apparatus for controlling a copy window during read-out of a magneto-optical recording medium (10) comprising a storage layer and a read-out layer, wherein an expanded domain leading to a reading pulse is generated in said read-out layer by copying a mark region from said storage layer to said read-out layer upon heating by a radiation power and with the help of an external magnetic field, said apparatus comprising:
means (34) for deriving a switching time of said external magnetic field from said reading pulse;
means (34) for determining a shift in the timing of said reading pulse; and
means (34, 14, 30) for controlling the size of said copy window based on said determined timing shift.

17. An apparatus according to claim 16, wherein said determination means (34) comprises a timer means for counting said time shift.

18. An apparatus according to claim 16, wherein said apparatus is a disk player for MAMMOS disks.
